(19) United States
(12) Patent Application Publication
(10) Pub. No.: US 2024/0239718 A1
(43) Pub. Date: Jul. 18, 2024

(54) REPLACEMENT PRODUCTS USING BIOCHAR AND METHOD FOR MANUFACTURE

(71) Applicant: BIOFORCETECH CORPORATION, San Francisco, CA (US)

(72) Inventors: DARIO PRESEZZI, San Francisco, CA (US); VALENTINO VILLA, San Francisco, CA (US); STEFANO PESSINA, San Francisco, CA (US); ELIZABETH BRIDGES, San Francisco, CA (US); GARRETT BENISCH, San Francisco, CA (US)

(73) Assignee: BIOFORCETECH CORPORATION, San Francisco, CA (US)

(21) Appl. No.: 18/565,393

(22) PCT Filed: Jun. 1, 2022
(86) PCT No.: PCT/US2022/031805

§ 371 Date: Nov. 29, 2023

Related U.S. Application Data
(60) Provisional application No. 63/196,607, filed on Jun. 3, 2021.

(51) Int. Cl. C05F 17/60; C05F 11/00; C05G 3/80; C05G 5/10

(52) U.S. Cl. CPC C05F 17/60; C05F 11/00; C05G 3/80; C05G 5/10

(57) ABSTRACT

Replacement products using biochar made from biosolids may be manufactured that may include soil amendment products, concrete, carbon black, fabric dyes, filtration materials and pigments.

### CROSS-REFERENCE TO RELATED APPLICATION(S)

The present application claims priority to U.S. Provisional Patent Application No. 63/196,607, titled “REPLACEMENT PRODUCTS USING BIOCHAR AND METHOD FOR MANUFACTURE” and filed Jun. 3, 2021, the entirety of which is incorporated by reference herein.

### FIELD

The disclosure relates to using biochar as a replacement element in various processes and in particular to the use of biosolids biochar as a replacement element in various processes.

### BACKGROUND

Throughout modern history, biosolids have been disposed of in environmentally harmful and toxic ways. First, was dumping of sludge in waterways, then landfilling, and now, at best, land application. In landfilling, all organic materials break down both aerobically and anaerobically in a landfill. Aerobically broken down organics emit CO2. Anaerobically broken down organics emit methane, a greenhouse gas that is 20-84 times more powerful in warming potential than CO2. Conservative estimates put any given amount of organics breaking down into half CO2 and half methane in landfill. Landfilling is clearly not a good way to dispose of biosolids.

When biosolids/sludge are discharged into waterways, pollutants in the water, nutrients creating algal blooms, risk of infection to swimmers and recreational users of waterways, drinking water contamination, ecosystem destruction, etc. are some of the problems. When the biosolids/sludge are disposed of by land application, the presence of microplastics, PFAS, PFOA, and PFOS, and other chemicals of emerging concern (CECs) in biosolids makes land application, a method currently characterized as ‘beneficial use,’ a harmful practice and a risk to environmental and human health.

In today's world, there are a number of environmentally harmful products in various industries. Dyes, concrete, colorants, and filtration substances are examples. For example, carbon black is a ubiquitous colorant and material additive, and is created by burning fossil fuels to deposit a soot like substance. It has a large carbon footprint and can be found in nearly every goods/manufacturing sector including clothing, car tires, plastics, paints and finishes, and more. Another example is activated carbon that is used as filtration media. Activated carbon requires additional chemical and energy intensive processing to be created.

The known techniques to environmentally dispose of biosolids have failed due to a large carbon footprint and by allowing toxicity to proliferate into the environment. Other forms of biosolids disposal fail by either emitting tons of greenhouse gasses (landfill), proliferating toxic chemicals into the environment (land application), requiring intense external energy inputs and yielding a less useful byproduct (incineration), or causing direct ecosystem destruction (disposal into waterways). Drying and pyrolysis systems other than the ones described in these claims use intense external energy, are not modular or scalable to meet a wide variety of flow capacities, and do not yield a byproduct as clean, chemical free, and consistent as the output described in these claims. Fossil Fuel intensive materials have unsustainable carbon footprints and can often cause human health from exposure during manufacturing and use of products that include them. Thus, it is desirable to provide a technical solution to the above problems (some technical) with the known techniques and failed solutions and it is to this end that the disclosure is directed.

### SUMMARY

In a first example embodiment, a method for making a soil amendment product is provided. The method can include drying a biosolid to remove water resulting in a dried biosolid. The method can also include capturing the removed water. The removed water can have one or more nutrients originally present in the biosolid. The method can also include carbonizing the dried biosolid using a pyrolysis process to generate biochar. The method can also include inserting the removed water back into the biochar to generate a nutrient rich biochar soil amendment product.

In some instances, inserting the removed water back into the biochar further comprises spraying the removed water back onto hot biochar generated by the carbonizing.

In some instances, spraying the removed water back onto hot biochar further comprises condensing nitrogen and phosphor into the hot biochar.

In another example embodiment, a soil amendment product is provided. The soil amendment product can include a plurality of pieces of biochar wherein each piece of biochar is carbonized biosolid. The soil amendment product can also include one or more nutrients inserted onto or into some of the plurality of pieces of biochar to produce a plurality of pieces of nutrient rich biochar. The plurality of pieces of nutrient rich biochar can be absorbed nutrients from water removed during drying of the biochar that is inserted back onto the plurality of pieces of biochar after the carbonization to generate the plurality of pieces of biochar.

In some instances, the one or more nutrients are sprayed onto the plurality of pieces of biochar after the carbonization to generate the nutrient rich plurality of pieces of biochar.

In some instances, the one or more nutrients are nitrogen and phosphor condensed onto the plurality of pieces of biochar after the carbonization to generate the plurality of pieces of biochar.

In another example embodiment, a method for manufacture a replacement product using a biosolid biochar is provided. The method can include drying a biosolid to remove water resulting in a reduced water content biosolid. The method can also include carbonizing the reduced water content biosolid using a pyrolysis process to generate a plurality of pieces of biochar. The method can also include forming a replacement product using the biochar.

In some instances, the replacement product is a plurality of pieces of grit for concrete.

In some instances, the method can include micronizing the plurality of pieces of biochar to generate a micronized biochar material.

In some instances, forming the replacement product using the micronized biochar material further comprises forming one of a dye, a pigment, a ceramic additive, a material additive, and a substitute for carbon black.

In some instances, the replacement product is a plurality of pieces of grit created by producing biosolids biochar at temperatures between 450° C. and 750° C.

In some instances, the grit being added to a concrete mix has a fineness modulus between 1 and 5, and wherein the grit is added to equal from 0.5% to 30% of a total volume within the mix, replacing from 1% to 100% of sand in the concrete mix.

In some instances, the biochar generated is produced at pyrolysis temperatures between 450° C. and 750° C. to generate an optimal material to color printing media.

In some instances, the biochar is micronized to a size between 0.01 and 50 microns.

In some instances, biochar is created that is suitable for producing pigment for polymer based filaments with pyrolysis temperatures between 450° C. and 750° C.

In some instances, the method can include micronizing the biochar to a size between 0.01 and 10 microns.

In some instances, the biochar generated is produced at pyrolysis temperatures between 450° C. and 750° C. to generate an optimal material to add to and color polymers.

In some instances, the method can include micronizing the biochar to a size between 0.01 and 100 microns.

In some instances, the biochar generated is produced at pyrolysis temperatures between 450° C. and 750° C. to generate an optimal fabric dye.

In some instances, the method can include micronizing biochar to a size between 0.01 and 2 microns.

### BRIEF DESCRIPTION OF THE DRAWINGS

FIG. 1 illustrates a biochar process according to some embodiments.

FIG. 2 illustrates a biochar process that may be used to produce the biochar for the replacement products according to some embodiments.

FIG. 3 illustrates a process for manufacturing a soil amendment product using biochar according to some embodiments.

FIG. 4 illustrates a process for manufacturing a colorant using biochar according to some embodiments.

FIG. 5 illustrates a process for manufacturing a concrete additive using biochar according to some embodiments.

FIG. 6 illustrates a process for manufacturing a ceramic additive using biochar according to some embodiments.

FIG. 7 illustrates a process for manufacturing fabric dye using biochar according to some embodiments.

FIG. 8 illustrates a process for filtration using biochar according to some embodiments.

FIG. 9 illustrates a process for manufacturing pigment using biochar according to some embodiments.

### DETAILED DESCRIPTION

The disclosure is particularly applicable to using commercially produced biochar for a variety of use cases described below and it is in this context that the disclosure will be described. It will be appreciated, however, that the disclosure has greater utility, such as that it may also be used for other use cases in accordance with the disclosure. The biochar base material generated by this process may be used to replace market available products that are environmentally harmful, products whose manufacture releases a significant quantity of greenhouse gasses or uses a lot of energy. One such base material which could be replaced by this biochar is the ubiquitous carbon black colorant. The biochar material is a direct replacement for carbon black and provides strong environmental benefits since the manufacturing process is created from waste organics.

The disclosed use case and method of manufacture also may be used to produce a replacement for activated charcoal that may be used as an element of various filtering products. Although industry standard activated charcoal is able to filter particulate matter more efficiently than biosolids biochar, this material replacement is far less cost prohibitive and can filter as effectively so long as volume of material is increased proportionally to the difference in filtration efficiency between the two materials. The biosolids biochar manufactured replacement products also may be used for concrete (as a partial sand replacement that captures CO2 in the concrete), for dyes and for soil amendment as disclosed below.

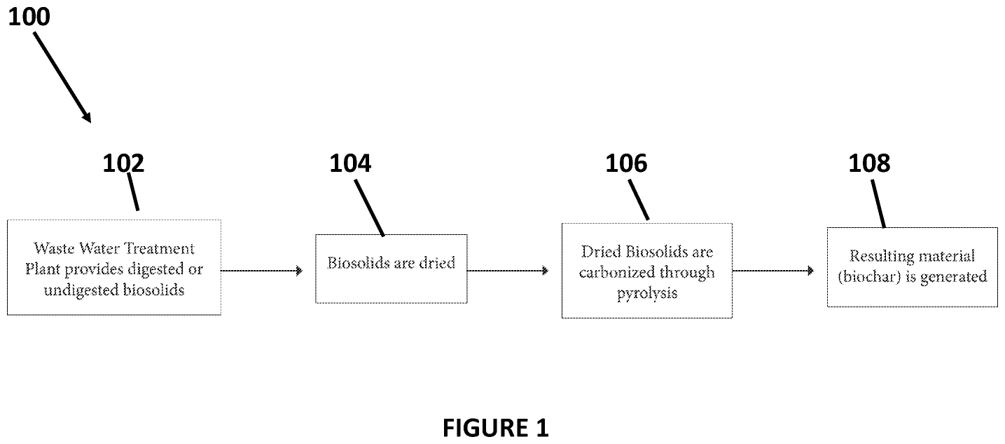

FIG. 1 illustrates a process 100 for making biochar. In the process, a wastewater treatment plant provides digested or undigested biosolids (102) that may be dried (104) to remove some of the water content. The dried biosolids may then be carbonized through pyrolysis (106) As a result of the pyrolysis, a biochar is generated (108).

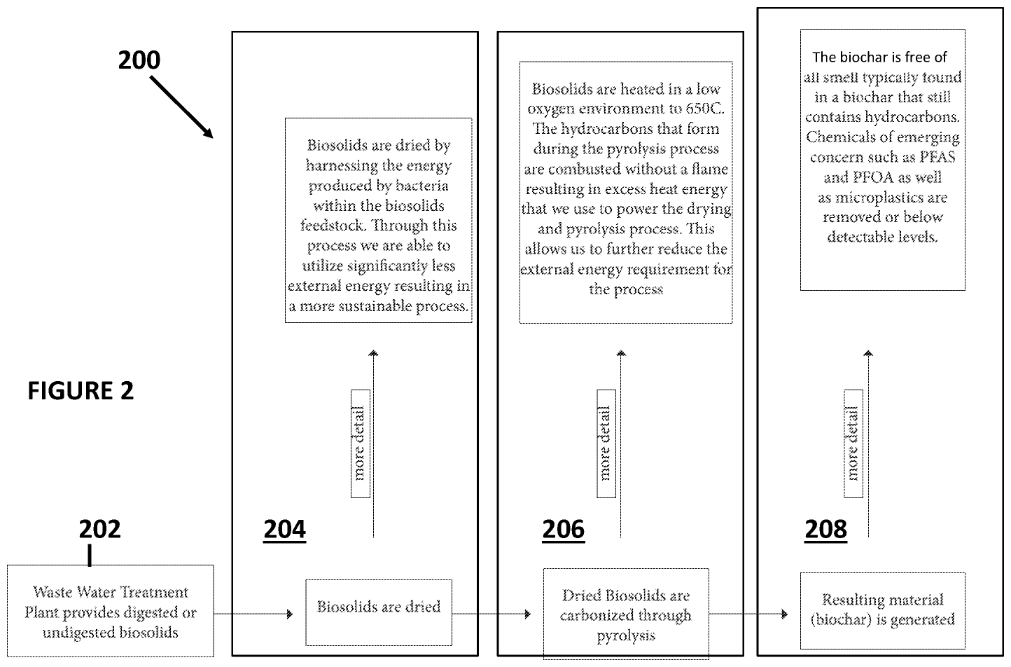

FIG. 2 illustrates a biochar process 200 that may be used to produce the biochar for the replacement products in which the same digested or undigested biosolids are provided as input (202). In this process 200, the biosolids are dried (204) in a process in which the biosolids are dried by harnessing the energy produced by bacteria within the biosolid feedstock to use significantly less external energy resulting in a more sustainable process. For example, the process may require approximately 50% less energy than competing biosolids drying technology. Once the biosolid is dried, it may be carbonized using a pyrolysis process (206) in which the biosolids are heated in a low oxygen environment to between 200 C and 900 C depending on the end use of the material. At these temperatures, the hydrocarbons formed during the pyrolysis process are combusted and the resultant heat is utilized. The process may be various different combustion processes that may be with or without a flame. This results in excess heat energy that the process uses to power the pyrolysis and drying processes and thus can reduce the external energy requirements. Now, the resulting biochar material is produced (208). The produced biochar is free of any smell since the hydrocarbons have been combusted and the chemicals of emerging concern and microplastics discussed above are removed or below detectable levels. This resulting biochar produced using the process 200 in FIG. 2 may be used as part of the replacement products and manufacture of these replacement products discussed below in more detail. Note that the present biochar contains captured carbon which is locked in place and prevented from entering the atmosphere for thousands of years thanks to the pyrolysis process after drying. The positive environmental impact is compounded when the waste organic material utilized as a feedstock for the pyrolysis process is diverted from landfill, where it would break down anaerobically and release methane. Furthermore, the present biochar, for each replacement product, can reduce the environmental impact caused by the known products being replaced by the biochar. A third-party assessment of the biochar was completed using the BEAM Model that is the standard model developed/used for wastewater industry life cycles. The third-party assessment concluded that this system prevents 10 tons of CO2e from being emitted into the atmosphere per ton of output material created when compared to typical landfill disposal methods of biosolids and not including the carbon emission avoidance of replacing other materials with the output biochar.

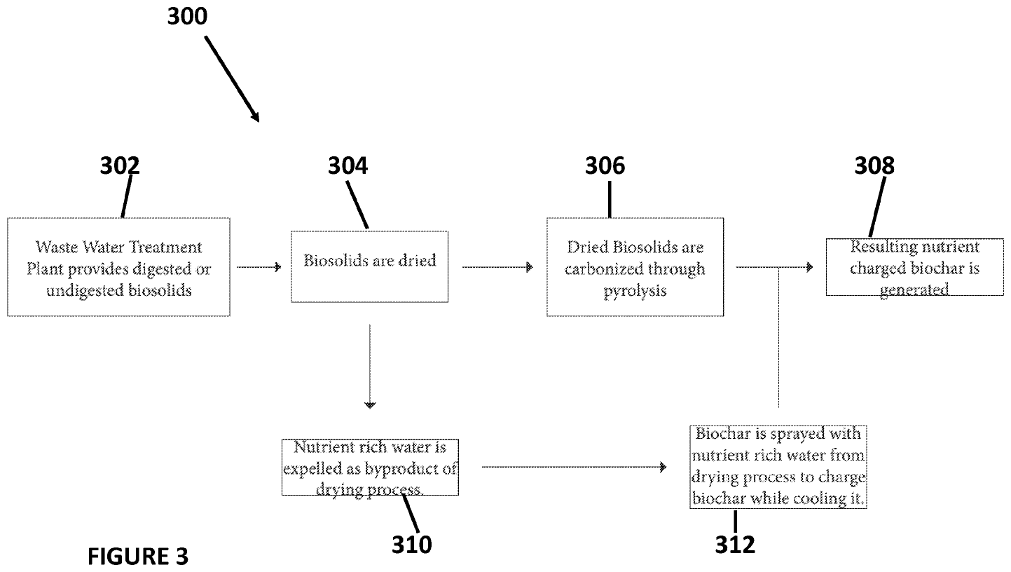

FIG. 3 illustrates a process 300 for manufacturing a soil amendment product using the biochar made with the process shown in FIG. 2. In the soil amendment process 300, the digested or undigested biosolids (such as from a wastewater treatment plant) may be fed (302) into the process. The biosolids may be dried (304). During the drying process 304, nutrient rich water is expelled as a byproduct of the drying process and saved (310). The dried biosolids may then be carbonized (306) through a pyrolysis process such as by using the commercially available BioForceTech pyrolysis unit. The output from the pyrolysis process (the dried biosolids carbonized at high temperature into a biosolids biochar) may be sprayed with the nutrient rich water (312) to change the biochar before it cools resulting in a nutrient charged biochar (308). This process 312 allows nitrogen and phosphorus to condense onto/into biochar during the cooling process of the hot char. This allows the biochar to absorb the nutrients and release them over time to plants during watering cycles.

The nutrient charged biochar may be used for soil amendment. The density of the biosolids biochar is the same as most soil, causing it to stay in place and not float to the surface during waterings as is a common issue with wood based biochars. The porous structure of the biochar causes it to play a role much like pumice in soils, aerating soils, holding water and nutrients in pores and creating a structure for microbes to inhabit and flourish, benefiting soil microbiology. Based on input levels of nutrients in the initial biosolids feedstock, this production process can yield a biosolids biochar which recovers and maintains between 20% and 50% of the original Nitrogen content and between 50% and 90% of the original Phosphorus and Potassium content, making this a potent fertilizing amendment beside the inherent beneficial soil amendment properties of the material.

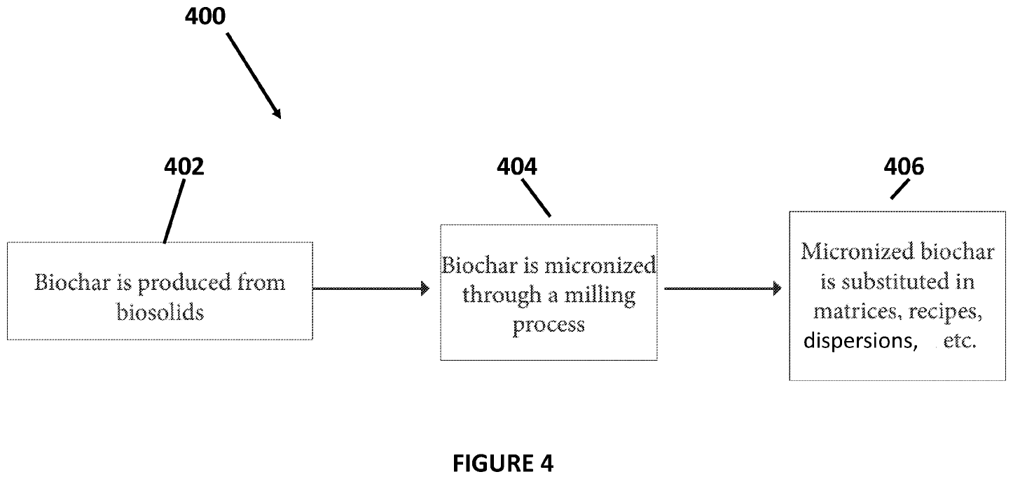

FIG. 4 illustrates a process 400 for manufacturing a pigment/colorant using biochar produced by the process 200 in FIG. 2. The biochar suitable for producing pigment may be generated with pyrolysis temperatures between 450° C. and 750° C. to assure that no volatile organics are present in the biochar and to eliminate hydrocarbons to lower than 0.001 mg/kg. One application example of the colorant is its ability to replace known carbon black, but the process also may be used to produce other colorants or replacement for material additives and fillers. In the process, biochar is produced from biosolids (402) as discussed above and the biochar is micronized (404) through a process, such as milling. The range of particle sizes resulting from the micronizing is variable depending on the length of the micronization process, but the particles may be as small as 500 nanometers or as large as 50 micron depending on its intended end use. The resultant micronized biochar may be substituted (406) in matrices, recipes, dispersions, etc. in products that would otherwise use carbon black or other black pigments. Alternatively, the resultant micronized biochar may be used as a micronized material additive and or filler, such as a filler for plastics that allows the manufacturer to use less raw plastic in a production process. Micronizing biochar to a size between 0.01 and 50 microns for applications in printing media, paints, and other such finishes optimizes dispersion in printing media and ensures optimal coloring of the final printed product with the addition of 1% to 20% micronized biochar in the final ink or paint. Micronizing biochar to a size between 0.01 and 10 microns for applications in extruded polymer fibers helps to assure dispersion in the polymer base. In addition, this particle size is necessary to maintain the mechanical properties of the extruded polymer fiber. Micronizing biochar to a size between 0.01 and 100 microns for applications in plastics manufacturing such as, but not limited to, masterbatching, compounding, injection molding, etc. assures optimal dispersion in the polymer base, and guarantees full coloring of the final polymer products.

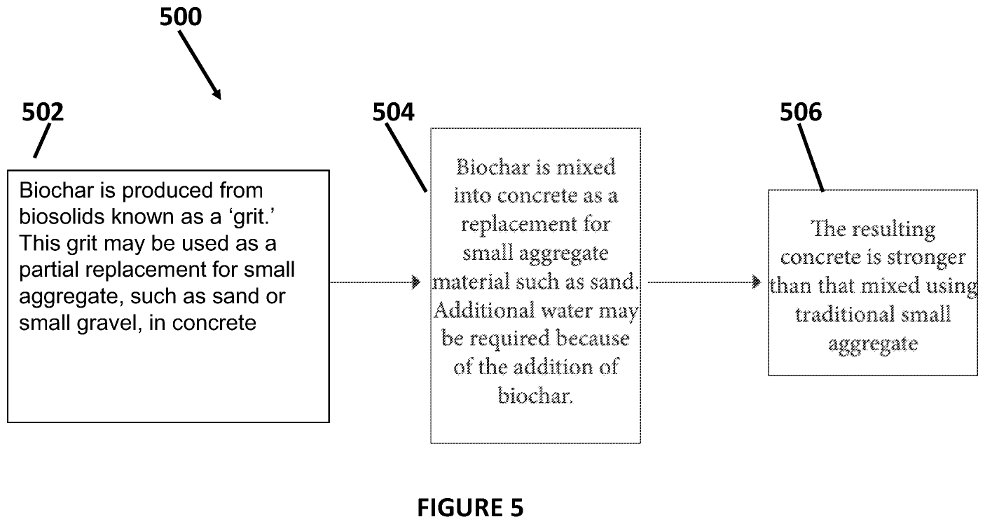

FIG. 5 illustrates a process 500 for manufacturing a concrete additive using biochar made with the process 200 shown in FIG. 2. As shown in FIG. 2, biochar is produced from biosolids (502). In this application, the biosolids biochar is known as a ‘grit’ material. This grit may be used as a replacement (504) for the small aggregate, such as sand or small gravel, that is normally present in concrete. It may also be utilized as an additive in concrete to increase strength, change cure time, change color, and add embodied carbon to the concrete to lower its carbon footprint. In different embodiments, the biochar may be micronized or may not be micronized. The mixing may require additional water due to the addition of the biochar. The resulting concrete, when set, is comparable in terms of strength (506) to concrete that uses traditional small aggregate and/or does not employ the biochar at all. In many cases, the addition of the biosolids biochar may increase the strength of the concrete. In addition, the use of the biosolid biochar means that the carbon dioxide that might otherwise be emitted from the biosolid material is locked into the concrete. This carbon embodiment can lower the carbon footprint overall of the concrete mix that the biochar has been added to making it an attractive option for project leaders recording the carbon footprint of their project. Additionally, the biosolids biochar may change the color of the concrete, deepening it to establish a new coloring specific to a mix with this additive and aiding in blending layers of concrete together where normally a stratified appearance is evident. Adding biochar grit with a fineness modulus between 1 and 5 is most suitable for this application. The grit should be added from 0.5% to 30% of volume in the concrete mix, replacing from 1% to 100% of sand in the concrete mix. Adding the grit in this range can also increase the compressive strength by at least 2% at 7 days period, consequently reducing curing time.

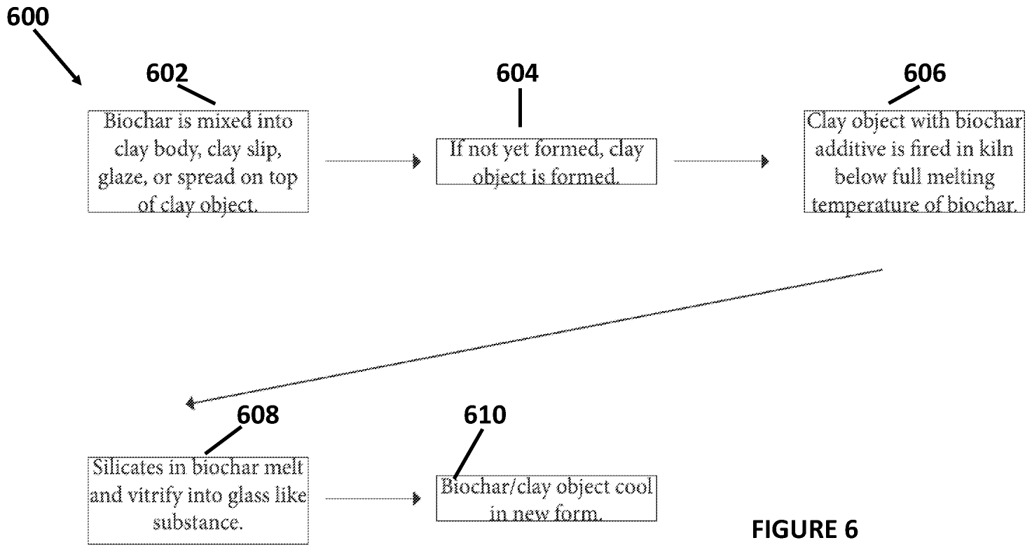

FIG. 6 illustrates a process 600 for manufacturing a ceramic additive using biochar in which the biochar is prepared using the process 200 in FIG. 2 described above. The produced biochar from biosolids may contain silicates. To make a ceramic additive, the biochar may be mixed into clay body, clay slip, glaze or spread on top of clay object (602). The clay object may be formed (604). The formed clay object may have the biochar in the clay or, in the case of a biochar spread, the biochar spread may be applied to the formed clay object. Once the clay object is formed with the biochar additive, it is fired in a kiln (606) that may be above or below the full melting temperature of the biochar. In the kiln, the silicates in the biochar melt and vitrify into a glass like substance (608). The object with the biochar additive may then be cooled (610). The self-vitrifying properties of this biochar is advantageous because it can reduce the need for a secondary kiln firing to form a glaze on a clay body, reducing the energy needed to produce a glazed ceramic piece. The biochar is unique in its silicate content as most other biochar feedstocks don't contain this material and thus cannot self-vitrify due to the lack of silicate content.

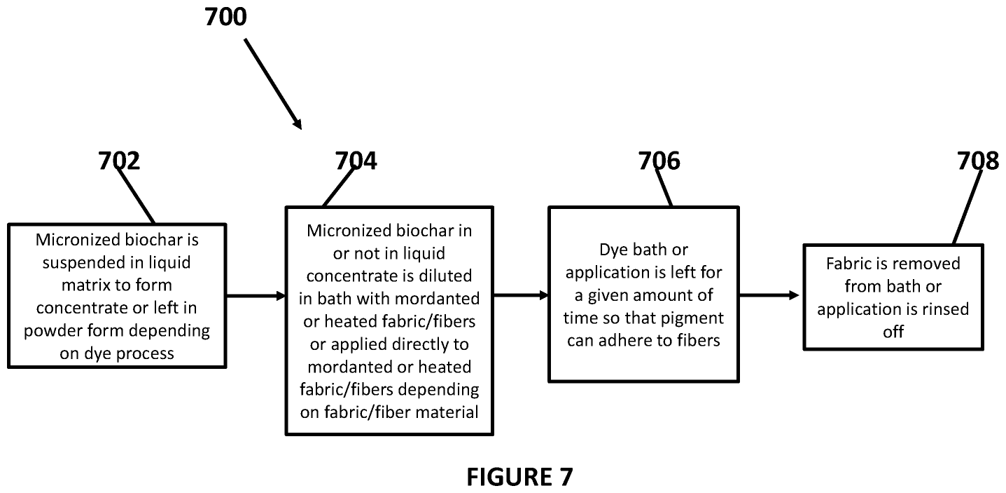

FIG. 7 illustrates a process 700 for manufacturing fabric dye using biochar that may be produced using the process 200 in FIG. 2 and has been micronized to a particle size of 1-25 micrometer as described above. The micronized biochar may be suspended in a liquid matrix (702) to form concentrate or left in powder form depending on the dye process. The micronized biochar (powder or liquid) may be suspended in bath with mordanted or heated fabric/fibers (704) or applied directly to mordanted or heated fabric/fibers depending on the fabric/fiber material. The dye bath or application is left for a given amount of time ranging from 20 minutes to an hour depending on the fabric used so that the pigment can adhere to the fibers (706) wherein the amount of time varies depending on the type of fabric. The fabric may be removed from the bath or application and rinsed off (708) to complete the use of the biochar pigment as a dye for fabric. Micronizing the biochar to a size between 0.01 and 2 microns is needed to increase coloring capacity of the dye bath.

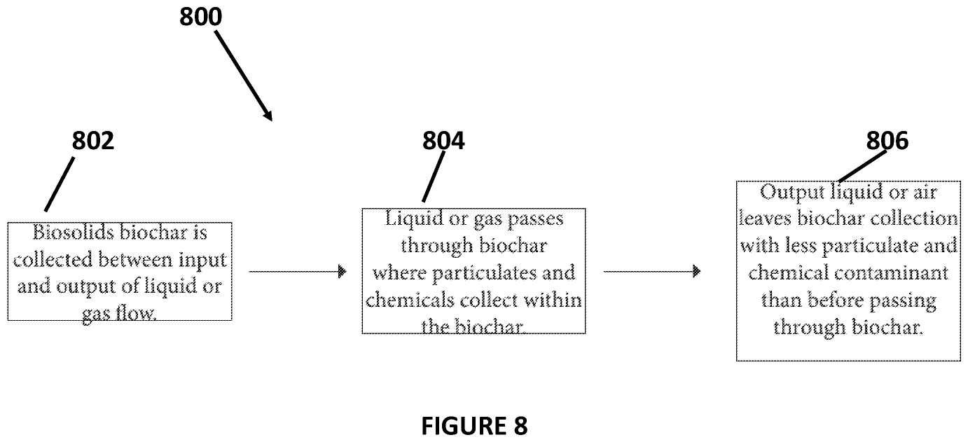

FIG. 8 illustrates a process 800 for filtration using biochar that is produced using the process 200 shown in FIG. 2. In the process, the biochar is produced that has properties similar to known activated charcoal, although the known activated charcoal has approximately double of the surface area of the biochar filter material. In using the biochar as a filtration material, the biosolid biochar with a surface area between 130 m2/g dry and 180 m2/g dry may be collected between an input and output of a liquid or gas flow with the biochar being used to filter the liquid or gas flow (802). During the filtration, liquid or gas passes through the biosolids biochar where particulates and chemicals are collected within the biochar (804). If the surface area is matched, the biochar filter material is comparable to the known filtration materials and thus have the same filtration effect. As a result of the filtering, the output liquid or air is cleaner (has less particulate matter and/or chemicals) as would be the case with the known filtration material (806).

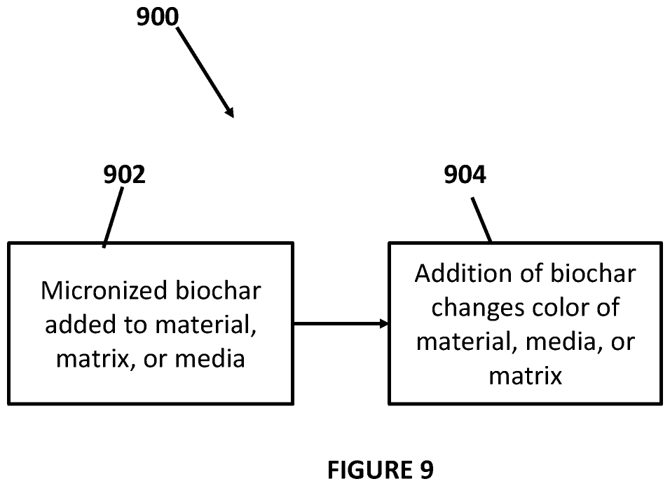

FIG. 9 illustrates a process for manufacturing pigment 900 using biochar in which the biochar is made using the process 200 shown in FIG. 2. For this pigment use case, the biosolid biochar may be micronized (described above) and added to the material, matrix or media (902) to change its color (904).

The foregoing description, for purpose of explanation, has been with reference to specific embodiments. However, the illustrative discussions above are not intended to be exhaustive or to limit the disclosure to the precise forms disclosed. Many modifications and variations are possible in view of the above teachings. The embodiments were chosen and described in order to best explain the principles of the disclosure and its practical applications, to thereby enable others skilled in the art to best utilize the disclosure and various embodiments with various modifications as are suited to the particular use contemplated.

Unless the context clearly requires otherwise, throughout the description, the words “comprise,” “comprising,” and the like are to be construed in an inclusive sense as opposed to an exclusive or exhaustive sense; that is to say, in a sense of “including, but not limited to.” Words using the singular or plural number also include the plural or singular number respectively. Additionally, the words “herein,” “hereunder,” “above,” “below,” and words of similar import refer to this application as a whole and not to any particular portions of this application. When the word “or” is used in reference to a list of two or more items, that word covers all of the following interpretations of the word: any of the items in the list, all of the items in the list and any combination of the items in the list. Although certain presently preferred implementations of the invention have been specifically described herein, it will be apparent to those skilled in the art to which the invention pertains that variations and modifications of the various implementations shown and described herein may be made without departing from the spirit and scope of the invention. Accordingly, it is intended that the invention be limited only to the extent required by the applicable rules of law.

While the foregoing has been with reference to a particular embodiment of the disclosure, it will be appreciated by those skilled in the art that changes in this embodiment may be made without departing from the principles and spirit of the disclosure, the scope of which is defined by the appended claims.

What is claimed is:

1. A method for making a soil amendment product, the method comprising:
drying a biosolid to remove water resulting in a dried biosolid;
capturing the removed water, the removed water having one or more nutrients originally present in the biosolid;
carbonizing the dried biosolid using a pyrolysis process to generate biochar; and
inserting the removed water back into the biochar to generate a nutrient rich biochar soil amendment product.

2. The method of claim 1, wherein inserting the removed water back into the biochar further comprises spraying the removed water back onto hot biochar generated by the carbonizing.

3. The method of claim 2, wherein spraying the removed water back onto hot biochar further comprises condensing nitrogen and phosphor into the hot biochar.

4. A soil amendment product, comprising:
a plurality of pieces of biochar wherein each piece of biochar is carbonized biosolid; and
one or more nutrients inserted onto or into some of the plurality of pieces of biochar to produce a plurality of pieces of nutrient rich biochar, wherein the plurality of pieces of nutrient rich biochar has absorbed nutrients from water removed during drying of the biochar that is inserted back onto the plurality of pieces of biochar after the carbonization to generate the plurality of pieces of biochar.

5. The product of claim 4, wherein the one or more nutrients are sprayed onto the plurality of pieces of biochar after the carbonization to generate the nutrient rich plurality of pieces of biochar.

6. The product of claim 5, wherein the one or more nutrients are nitrogen and phosphor condensed onto the plurality of pieces of biochar after the carbonization to generate the plurality of pieces of biochar.

7. A method for manufacture a replacement product using a biosolid biochar, the method comprising:
drying a biosolid to remove water resulting in a reduced water content biosolid;
carbonizing the reduced water content biosolid using a pyrolysis process to generate a plurality of pieces of biochar; and
forming a replacement product using the biochar.

8. The method of claim 7, wherein the replacement product is a plurality of pieces of grit for concrete.

9. The method of claim 7, further comprising:
micronizing the plurality of pieces of biochar to generate a micronized biochar material.

10. The method of claim 9, wherein forming the replacement product using the micronized biochar material further comprises forming one of a dye, a pigment, a ceramic additive, a material additive, and a substitute for carbon black.

11. The method of claim 7, wherein the replacement product is a plurality of pieces of grit created by producing biosolids biochar at temperatures between 450° C. and 750° C.

12. The method of claim 11, wherein the grit being added to a concrete mix has a fineness modulus between 1 and 5, and wherein the grit is added to equal from 0.5% to 30% of a total volume within the mix, replacing from 1% to 100% of sand in the concrete mix.

13. The method of claim 9, wherein the biochar generated is produced at pyrolysis temperatures between 450° C. and 750° C. to generate an optimal material to color printing media.

14. The method of claim 13, wherein the biochar is micronized to a size between 0.01 and 50 microns.

15. The method of claim 9, wherein biochar is created that is suitable for producing pigment for polymer based filaments with pyrolysis temperatures between 450° C. and 750° C.

16. The method of claim 15, the method can further comprise micronizing the biochar to a size between 0.01 and 10 microns.

17. The method of claim 9, wherein the biochar generated is produced at pyrolysis temperatures between 450° C. and 750° C. to generate an optimal material to add to and color polymers.

18. The method of claim 17, the method can further comprise micronizing the biochar to a size between 0.01 and 100 microns.

19. The method of claim 9, wherein the biochar generated is produced at pyrolysis temperatures between 450° C. and 750° C. to generate an optimal fabric dye.

20. The method of claim 19, the method can further comprise micronizing biochar to a size between 0.01 and 2 microns.
